(19) United States
(12) Patent Application Publication
(10) Pub. No.: US 2014/0141209 A1
(43) Pub. Date: May 22, 2014

(54) INK FOR INKJET RECORDING, AND INK CARTRIDGE, INKJET RECORDING METHOD, INKJET RECORDER AND INK-RECORDER MATTER USING THE INK

(71) Applicants: Yuusuke KOIZUKA, Shizuoka (JP); Kazukiyo Nagai, Shizuoka (JP); Mitsuru Naruse, Shizuoka (JP); Masayasu Nonogaki, Shizuoka (JP); Minoru Hakiri, Shizuoka (JP); Akihiko Matsuyama, Shizuoka (JP); Keita Katoh, Shizuoka (JP)

(72) Inventors: Yuusuke KOIZUKA, Shizuoka (JP); Kazukiyo Nagai, Shizuoka (JP); Mitsuru Naruse, Shizuoka (JP); Masayasu Nonogaki, Shizuoka (JP); Minoru Hakiri, Shizuoka (JP); Akihiko Matsuyama, Shizuoka (JP); Keita Katoh, Shizuoka (JP)

(21) Appl. No.: 14/050,731

(22) Filed: Oct. 10, 2013

(30) Foreign Application Priority Data
Nov. 19, 2012 (JP) 2012-253649

(51) Int. Cl. C09D 11/00

(52) U.S. Cl. CPC C09D 11/324; C09D 11/322
USPC 428/195.1; 524/88; 524/90; 524/388; 347/86; 347/20

(57) ABSTRACT

An ink for inkjet recording includes water; a water-soluble solvent; a pigment; and a copolymer including a salt of phosphonic acid group. The copolymer including a salt of phosphonic acid group includes structural units having the following formulae (1) and (2):

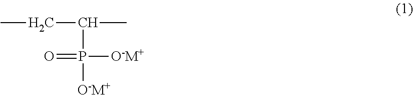

wherein M⁺ represents a cation of alkali metals, an organic ammonium ion or a proton, and wherein not less than a half of M⁺ are the cation of alkali metals and the organic ammonium ion;

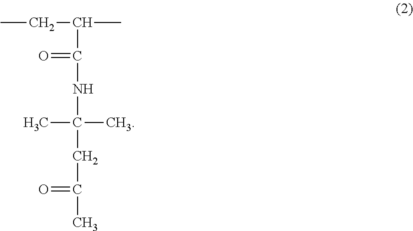

### CROSS-REFERENCE TO RELATED APPLICATIONS

This patent application is based on and claims priority pursuant to 35 U.S.C. §119 to Japanese Patent Application No. 2012-253649, filed on Nov. 19, 2012, in the Japan Patent Office, the entire disclosure of which is hereby incorporated by reference herein.

### BACKGROUND

1. Technical Field

The present invention relates to an ink for inkjet recording, an ink cartridge, an inkjet recording method, an inkjet recorder and an ink-recorded matter.

2. Description of the Related Art

Recently, inkjet recording methods have been popular as image forming methods because of having advantages of having simpler process and easier full-colorization than the other recording methods, and producing high-resolution images even with an apparatus having simple composition. The inkjet recording methods have a small amount of ink soar and adhere to recording media such as papers to form images thereon with an inkjet recorder, and applications thereof are expanding, e.g., personal and industrial printers and printings.

In the inkjet recorder, an aqueous ink using a water-soluble dye is mostly used as a colorant. However, the ink has disadvantages of having poor weatherability and water resistance. Therefore, a pigment ink using a pigment instead of the water-soluble dye has been studied recently. However, the pigment ink is still inferior to the dye ink in colorability, ink discharge stability and preservation stability. In company with improvement of higher-quality image technology of OA printers, even when recorded on plain papers as recording media with the pigment ink, image density equivalent to that of the dye ink is required. However, the pigment ink penetrates into a plain paper as a recording medium and pigment density at he surface of the paper lowers, resulting in lower image density. In order to dry the ink adhering to the recording medium quicker to print quicker, a penetrant is added to the ink for water to penetrate into the recording medium. Then, not only water but also pigment penetrates deeper into the recording medium, resulting in lower image density.

Various methods are disclosed to improve image density. For example, Japanese published unexamined application No. JP-2011-122072-A discloses an ink used for recording on a paper including a water-soluble multivalent metal salt. The ink includes (a) a pigment and (b) at least one compound having no surface activating ability, a molecular weight of from 150 to 10,000, and a content rate of phosphorous ((p/molecular weight)×100) from a functional group selected from a functional group having a basic skeleton of phosphoric acid and functional group having a basic skeleton of phosphonic acid not less than 1.4. Further, the ink includes the (b) compound of from 1.5 to 10.0% by weight.

However, the method disclosed in Japanese published unexamined application No. JP-2011-122072-A doe not sufficiently improve image density on a plain paper having a low content rate of a water-soluble multivalent metal salt. When the compound having a functional group selected from a functional group having a basic skeleton of phosphoric acid and functional group having a basic skeleton of phosphonic acid, the image density improves, but a pigment is not stably dispersed in an ink.

Namely, Japanese published unexamined application No. JP-2011-122072-A does not achieve high image density and stable dispersion of a pigment in an ink.

Because of these reasons, a need exists for an ink for inkjet recording producing images having high image density on plain papers and having good preservation stability.

### SUMMARY

Accordingly, one object of the present invention is to provide an ink for inkjet recording producing images having high image density on plain papers and having good preservation stability.

Another object of the present invention is to provide an ink cartridge containing the ink for inkjet recording.

A further object of the present invention is to provide an inkjet recording method using the ink for inkjet recording.

Another object of the present invention is to provide an inkjet recorder using the ink for inkjet recording.

A further object of the present invention is to provide an ink-recorded matter recorded by the ink for inkjet recording.

These objects and other objects of the present invention, either individually or collectively, have been satisfied by the discovery of an ink for inkjet recording, including water; a water-soluble solvent; a pigment; and a copolymer including a salt of phosphonic acid group. The copolymer including a salt of phosphonic acid group includes structural units having the following formulae (1) and (2):

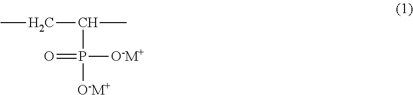

wherein M⁺ represents a cation of alkali metals, an organic ammonium ion or a proton, and wherein not less than a half of M⁺ are the cation of alkali metals and the organic ammonium ion;

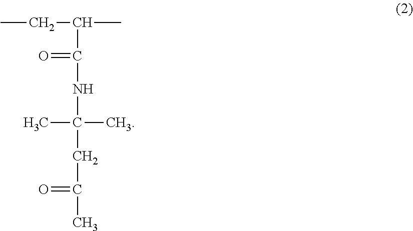

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic plain view illustrating an embodiment of a recording head (two-head type) equipped in the inkjet recorder of the present invention;

FIG. 2 is a schematic plain view illustrating another embodiment of a recording head (four-head type) equipped in the inkjet recorder of the present invention;

FIG. 3 is a perspective view illustrating an embodiment of the inkjet recorder of the present invention;

FIG. 4 is a schematic view illustrating an overall structure of the inkjet recorder in FIG. 3;

FIG. 5 is a schematic plain view illustrating a main part of the inkjet recorder in FIG. 3;

FIG. 6 is a schematic plain view illustrating a main part of a subsystem including a maintenance and recovery device in the inkjet recorder of the present invention;

FIG. 7 is a schematic view illustrating the subsystem in FIG. 6;

FIG. 8 is a schematic view illustrating the right side of the subsystem in FIG. 6; and

FIG. 9 is a schematic view illustrating a side of holding and elevating mechanism of a cap.

### DETAILED DESCRIPTION

The present invention provides an ink for inkjet recording producing images having high image density on plain papers and having good preservation stability.

The structural unit having the formula (1) reacts with the multivalent metal ion eluted from recording media when the ink lands on recording media such as plain papers to form aggregation of the pigment. As a result, penetration of the pigment into a paper is prevented and the image density becomes high.

Having the structural unit having the formula (2), the copolymer including a salt of phosphonic acid group has high affinity with a pigment when including the structural unit having the formula (2). As a result, dispersion of a pigment in the ink is improved and the ink has low viscosity. Further, dispersion stability of the pigment is improved and preservation stability of the ink is improved as well.

Mechanism of the aggregation of the pigment is not clarified, but is assumed as follows.

The phosphonic acid group or salt thereof in the structural unit having the formula (1) has high affinity with the multivalent metal ion and quickly coordinates with the multivalent metal ion eluted from the recording media.

When the copolymer including a salt of phosphonic acid group of the present invention is used as a dispersant, most thereof are adsorbed to the pigment in the ink. When the phosphonic acid group or salt thereof in the structural unit having the formula (1) coordinates with the multivalent metal ion eluted from the recording media, dispersion stability of the pigment in the ink deteriorates due to at least one of the following factors (1) to (3), resulting in aggregation of the pigment.

(1) The number of valences to ions increases and electrostatic repulsions between pigments decreases.

(2) The copolymer including a salt of phosphonic acid group of the present invention lowers in solubility in media, and polymer adsorption layer decreases and dimensional repulsions between pigments decreases.

(3) The copolymer including a salt of phosphonic acid group of the present invention lowers in solubility in media, and the pigment including it lowers in hydration stability. When the copolymer including a salt of phosphonic acid group of the present invention is used as an additive, it itself coordinates with the multivalent metal ion eluted from the recording media to form an insoluble matter, which becomes an aggregation core to cause aggregation of the pigment.

When the content rate of the structural unit having the formula (1) is low in the copolymer including a salt of phosphonic acid group of the present invention, the copolymer lowers in reactivity with the multivalent metal ion eluted from the recording media, resulting in deterioration of image density. In this respect, the content rate is preferably from 20 to 60% by weight, and more preferably from 30 to 60% by weight to improve image density and stabilize dispersion of the pigment in the ink. When not greater than 60% by weight, dispersion stability of the pigment does not deteriorate, which does not cause increase of viscosity and deterioration of preservation stability of the ink.

The copolymer including a salt of phosphonic acid group preferably has a weight-average molecular weight (Mw) of from 2,000 to 30,000 when measured by GPC polystyrene conversion. When not less than 2,000, the copolymer reacts with a multivalent metallic ion eluted from a recording medium to fully agglutinate a pigment, which does not cause deterioration of image density. When not greater than 30,000, dispersion stability of the pigment does not deteriorate, which does not cause increase of viscosity and deterioration of preservation stability of the ink.

Its is preferable that the phosphonic acid group is partially or wholly neutralized by a base and ionized.

Specific examples of the base neutralizing the phosphonic acid groups include inorganic alkaline agents such as potassium hydroxide and a sodium hydroxide; and organic amines such as triethylamine and diethanolamine.

The copolymer including a salt of phosphonic acid group of the present invention is synthesized from at least a vinyl phosphonic acid and a monomer having the following (3) as starting materials:

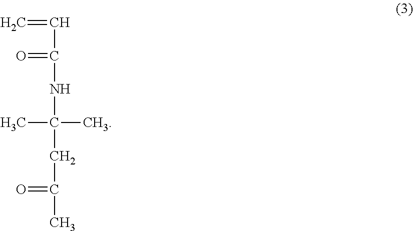

The monomer having the formula (3) is marketed as diacetone acrylic amide.

The copolymer including a salt of phosphonic acid group of the present invention is preferably synthesized by methods using a radical polymerization initiator because polymerization operation and molecular weight adjustment are simple. The solution polymerization methods in an organic solvent are more preferably used.

Specific preferred examples of solvents used in radical solution polymerization methods include ketone solvents such as acetone, methyl ethyl ketone and methyl isobutyl ketone; ester acetate solvents such as ethylacetate and butylacetate; aromatic hydrocarbon solvents such as benzene, toluene and xylene; isopropanol; ethanol; cyclohexane; tetrahydrofuran; dimethylformamide; dimethyl sulfoxide; hexamethylphosphoramide; etc. Ketone solvents, ester acetate solvents and alcohol solvents are more preferably used.

Specific examples of radical polymerization initiators include known materials such as peroxyketal, hydroperoxide, dialkylperoxide, diacylperoxide, peroxydicarbonate, peroxyester, cyano azobisisobutylonitrile, azobis(2,2′-isovaleronitrile), non-cyano dimethyl-2,2′-azobisisobutylate, etc. Organic peroxides and azo compounds having an easily-controllable molecular weight and a low decomposition temperature are preferably used, and the azo compounds are more preferably used. The polymerization initiators are preferably used in an amount of from 1 to 10% by weight based on total weight of polymerizable monomers.

In order to control a molecular weight of the copolymer including a salt of phosphonic acid group, chain transfer agents such as mercaptoacetate, mercaptopropionate, 2-propanethiol, thiophenol, dodecylmercaptane, 1-dodecanethiol and thioglycerol may be added in a proper amount.

The polymerization temperature is preferably from 50 to 150° C., and more preferably from 60 to 100° C. The polymerization time is preferably from 3 to 48 hrs.

Specific combinations of M in the formula (1) are shown in Table 1.

TABLE 1

| Combination No. | M in formula (1) |
|---|---|
| 1-1 | Na |
| 1-2 | Na, H |
| 1-3 | K |
| 1-4 | K, H |
| 1-5 | NH(CH₂CH₂OH)₃ |
| 1-6 | NH(Me)₃, H |
| 1-7 | NH₂(CH₂CH₂OH)₂ |
| 1-8 | NH(Et)₃, H |

Besides these combinations, the copolymers including a salt of phosphonic acid group having different compositional ratios and molecular weights of the formulae (1) and (2) can also be used.

Pigments for use in the present invention are not particularly limited, and carbon black is typically used as a black pigment.

Carbon black and color pigments are used as pigments.

Carbon black for use in the present invention is not particularly limited, and methods of preparing carbon black are not particularly limited, e.g., furnace methods and channel methods are used.

Marketed products can be used as carbon black. Specific examples thereof include No. 2300, No. 900, MCF-88, No. 3, No. 40, No. 45, No. 52, MA7, MA8, MA100 and No. 2200n from Mitsubishi Chemical Corp.; Raven 700, 5750. 5250, 5000, 3500 and 1255 from Columbian Chemicals Company; Regal 400R, 330R, 660R, Mogul L, Monarch 700, 800, 880, 900, 1000, 1100, 1300, Monarch 1400 from Cabot Corp.; Color Black FW1, FW2, FW2V, FW18, FW200, S150, S160, S170 from Degussa AG; Printex 35, U, V, 140U, 140V from Degussa AG; Special Black 6, 5, 4A, 4 from Degussa AG; etc.

The carbon black preferably has an average primary particle diameter of from 15 to 40 nm.

The carbon black preferably has specific surface area of from 50 to 300 m²/g.

Color pigments for use in the present invention are not particularly limited, and include yellow pigments, magenta pigments, cyan pigments, etc.

Specific examples of the yellow pigments include C.I. Pigment Yellow 1 (Fast Yellow G), 2, 3, 12 (disazo yellow AAA), 13 14, 16, 17, 20, 23, 24, 34, 35, 37, 42 (yellow iron oxide), 53, 55, 73, 74, 75, 81, 83 (disazo yellow FIR), 86, 93, 95, 97, 98, 100, 101, 104, 108, 109, 110, 114, 117, 120, 125, 128, 129, 137, 138, 139, 147, 148, 150, 151, 153, 154, 155, 166, 168, 180, 185, etc.

Specific examples of the magenta pigments include C.I. Pigment Red 1, 2, 3, 5, 7, 9, 12, 17, 22 (Brilliant Fast Scarlet), 23, 31, 38, 48:1 (Parmanent Red 2B (Ba)), 48:2 (Parmanent Red 2B (Ca)), 48:3 (Parmanent Red 2B (Sr)), 48:4 (Parmanent Red 2B (Mn)), 49:1. 52:2, 53:1, 57:1, (Brilliant Carmine 6B), 60:1, 63:1, 63:2, 64:1, 81 (Rhodamine 6G Lake), 83, 88, 92, 97, 101 (red iron oxide), 104, 105, 106, 108 (Cadmium Red), 112, 114, 122 (dimethyl quinacridon), 123, 146, 149, 166, 168, 170, 172, 175, 176, 178, 179, 180, 184, 185, 190, 192, 193, 202, 209, 215, 216, 217, 219, 220, 223, 226, 227, 228, 238,240, 254, 255, 272, etc.

Specific examples of the cyan pigments include C.I. Pigment Blue 1, 2, 3, 15 (Copper Phthalocyanine Blue R), 15:1, 15:2, 15:3 (Phthalocyanine Blue G), 15:4, 15:6 (Phthalocyanine Blue E), 16, 17:1, 22, 56, 60, 63, 64, Bat Blue 4, Bat Blue 60, etc.

Specific examples of additive color pigments include C.I. Pigment Red 177, 194, 224, C.I. Pigment Orange 16, 36, 43, 51, 55, 59, 61, 71, C.I. Pigment Violet 3, 19, 23, 29, 30, 37, 40, 50, C.I. Pigment Green 7, 36, etc.

The pigment preferably has a volume-average particle diameter of from 10 to 150 nm, more preferably from 20 to 100 nm, and furthermore preferably from 30 to 80 nm. When not less than 10 nm, light resistance and preservation stability of the resultant ink do not deteriorate. When not greater than 150 nm, color saturation of the resultant images do not deteriorate, the resultant ink does not increase in viscosity or agglutinate, and printer nozzles are not clogged.

The volume-average particle diameter is measured by, e.g., Microtrac UPA-150 from NIKKISO CO., LTD. A sample to be measured is diluted by pure water so as to have a pigment density of 0.01% by weight. The volume-average particle diameter means a 50% average particle diameter (D50) measured at particle refraction index of 1.51, a particle density of 1.4 g/cm³ and 23° C. using pure water parameter as a solvent parameter.

In the present invention, surfactant-treated carbon black particles or color pigment particles, on the surface of which a surfactant is adsorbed can be used.

The surfactant-treated carbon black particles are not particularly limited if the carbon black and a surfactant present on the surface thereof are included.

The surfactant-treated color pigment particles are not particularly limited if the color pigment and a surfactant present on the surface thereof are included.

Hereinafter, the surfactant-treated carbon black particles and the surfactant-treated color pigment particles are referred to as “surfactant-treated pigment particles”.

The surfactant-treated pigment particles are obtained by treating the pigments with the following surfactants. Specifically, the pigments are dispersed in water using the surfactants.

In the present invention, a surfactant may be added to the ink.

The surfactants are not particularly limited, and include, e.g., nonionic surfactants, anionic surfactants, ampholytic surfactants, etc.

Specific examples of the nonionic surfactants include, but are not limited to, polyoxyethylenealkylethers such as polyoxyethylenelaurylether, polyoxyethylenemyristylether, polyoxyethylenecetylether, polyoxyethylenestearylether and polyoxyethyleneoleylether; polyoxyethylenealkylphenylethers such as polyoxyethyleneoctylphenylether and polyoxyethylenenonylphenylether; polyoxyethylene-α-naphthylether; polyoxyethylene-β-naphthylether; polyoxyethylenemonostyrylphenylether; polyoxyethylenedistyrylphenylether; polyoxyethylenealkylnaphthylether; polyoxyethylenemonostyrylnaphthylether; polyoxyethylenedistyrylnaphthylether; etc.

Further, surfactants of polyoxyethylene polyoxypropylene block copolymers formed by replacing a part of polyoxyethylene of these surfactants with polyoxypropylene, and surfactants formed by condensing a compound having an aromatic ring such as polyoxyethylenealkylphenylether with formaldehyde can also be used.

The nonionic surfactants preferably have an HLB of from 12.0 to 19.5. and more preferably from 13.0 to 19.0. When not less than 12.0, the surfactants do not have affinity with dispersion media and dispersion stability does not deteriorate. When not greater than 19.5, the surfactants are difficult to adsorb to the pigment and dispersion stability does not deteriorate.

Specific examples of the anionic surfactants include, but are not limited to, polyoxyethylenealkylether sulfate, polyoxyethylenealkylphenylether sulfate, polyoxyethylenemonostyrylphenylether sulfate, polyoxyethylenedistyrylphenylether sulfate, polyoxyethylenealkylether phosphate, polyoxyethylenealkylphenylether phosphate, polyoxyethylenemonostyrylphenylether phosphate, polyoxyethylenedistyrylphenylether phosphate, polyoxyethylenealkylether carboxylate, polyoxyethylenealkylphenylether carboxylate, polyoxyethylenemonostyrylphenylether carboxylate, polyoxyethylenedistyrylphenylether carboxylate, naphthalene sulfonate formaldehyde condensate, melamine sulfonate formaldehyde condensate, dialkyl sulfosuccinate, alkyl sulfosuccinate disalt, polyoxyethylenealkyl sulfosuccinate disalt, alkyl sulfoacetate, α-olefin sulfonate, alkylbenzenesulfonate, alkylnaphthalene sulfonate, alkyl sulfonate, N-acylamino acid salt, acyl peptide, soap, etc.

Metals used for these salts are not particularly limited, and include potassium, sodium, magnesium, calcium, etc.

Methods of preparing the surfactant-treated pigment particles are not particularly limited, and include a method of dispersing a mixture in which the pigment, the surfactant and water are mixed.

The mixture preferably includes the surfactant in an amount of from 10 to 50% by weight based on total weight of the pigment. When not less than 10% by weight, preservation stability of the ink does not deteriorate and dispersion does not take so much time. When not greater than 50% by weight, the ink does not have so high viscosity as to deteriorate discharge stability.

The black and color inks use water as a medium and preferably include a water-soluble solvent for the purpose of preventing the ink from being dried and improving dispersion stability of the pigment.

The water-soluble solvents are not particularly limited, and polyol having an equilibrium water content not less than 40% by weight in an environment of 23° C. and 80% Rh. The polyols are not particularly limited, and a water-soluble solvent A having a boiling point greater than 250° C. at normal pressure and a water-soluble solvent B having a boiling point not less than 140° C. and less than 250° C. at normal pressure are preferably used together.

Specific examples of the water-soluble solvent A include 1,2,3-butanetriol, 1,2,4-butanetriol (bp 190 to 191° C./24 hPa), glycerin (bp 290° C.), diglycerin (bp 270° C./20 hPa), triethylene glycol (bp 285° C.), tetraethylene glycol (bp 324 to 330° C.), etc.

Specific examples of the water-soluble solvent B include diethylene glycol (bp 245° C.), 1,3-butanediol (bp 203 to 204° C.), etc.

The water-soluble solvents A and B are both hygroscopic materials having an equilibrium water content not less than 40% by weight in an environment of 23° C. and 80% Rh. However, the water-soluble solvent B is more comparatively evaporable than the water-soluble solvent A.

When the water-soluble solvents A and B are used in combination, a weight ratio (B/A) of the water-soluble solvent B to the water-soluble solvent A is preferably from 10/90 to 90/10 although depending not a little on an amount of a water-soluble solvent C mentioned later and other additives such as a penetrant.

Potassium chloride saturated aqueous solution is placed in a desiccator in which 23±1° C. and 80±3% Rh are maintained and a petri dish on which each 1 g of the water-soluble solvents is placed is stored in the desiccator to determine the equilibrium water content from a saturated amount of water.

Saturated amount of water (%)=(amount of water absorbed in an organic solvent/organic solvent)×100

The black ink and the color ink may include a water-soluble solvent C together with the water-soluble solvents A and B when necessary.

Specific examples of the water-soluble solvent C include polyol, polyol alkyl ethers, polyol aryl ether, nitrogen-containing heterocyclic compounds, amides, amines, sulfur-containing compounds, propylene carbonate, ethylene carbonate, other water-soluble solvents, etc.

Specific examples of the polyol include dipropylene glycol (bp 232° C.), 1,5-pentanediol (bp 242° C.), 3-methyl-1,3-butanediol (bp 203° C.), propylene glycol (bp 187° C.), 2-methl-2,4-pentanediol (bp 197° C.), ethylene glycol (bp 196 to 198° C.), tripropylene glycol (bp 267° C.), hexylene glycol (bp 197° C.), polyethylene glycol (viscosity liquid to solid), polypropylene glycol (bp 187° C.), 1,6-hexanediol (bp 253 to 260° C.), 1,2,6-hexanetriol (bp 178° C.), trimethylolethane (solid, mp 199 to 201° C.), trimethylolpropane (solid, mp 61° C.), etc.

Specific examples of the polyol alkyl ethers include ethyleneglycolmonoethylether (bp 135° C.), ethyleneglycolmonobutylether (bp 171° C.), ethyleneglycolmonomethylether (bp 194° C.), diethyleneglycolmonobutylether (bp 231° C.), ethyleneglycolmono-2-ethylhexylether (bp 229° C.), propyleneglycolmonoethylether (bp 132° C.), etc.

The black ink and the color ink preferably includes the water-soluble solvent in an amount of from 10 to 50% by weight.

The ink including the surfactant lowers in surface tension and penetrates recording media such as papers quicker, and feathering and color bleed are lessened.

Fluorine surfactants and silicone surfactants are preferably used, and combination thereof is more preferably used because image density, discharge stability and discharge recovery improve.

Specific examples of the fluorine surfactants include, but are not limited to, perfluoroalkylsulfonate, perfluoroalkylcarboxylate, perfluoroalkylphosphate ester, adducts of perfluoroalkylethyleneoxide, perfluoroalkylbetaine, perfluoroalkylamineoxide compounds, polyoxyethyleneperfluoroalkylether, etc.

As the fluorine surfactants, marketed products can be used. Specific examples of the marketed products include Surflon S-111, S-112, S-113, S121, S131, S132, S-141, S-144 and S-145 from Asahi Glass Co., Ltd.; Fluorad FC-93, FC-95, FC-98, FC-129, FC-135, FC-170C, FC-430, FC-431 and FC-4430 from Sumitomo 3M Corp.; MEGAFAC F-470, F-1405 and F474 from DIC Corp.; Zonyl FSN, FSN-100, FSO, FSO-100 and FS-300 from DuPont; Eftop EF-351, 352, 801 and 802 from Jemco; FT-250 and 251 from Neos Company Limited; PF-151N, PF-136A and PF-156A from OMNOVA Solutions Inc.; etc. Among these, Zonyl FSN, FSN-100, FSO, FSO-100 and FS-300 from DuPont are preferably used in terms of good printed quality and preservation stability.

The silicone surfactants are not particularly limited, and include polyether-modified silicone compounds, etc.

Specific examples of the polyether-modified silicone compounds include side chain (pendant) types in which a polyether group is introduced to a side chain of polysiloxane, one terminal types in which a polyether group is introduced to one terminal of polysiloxane, both terminal (ABA) types in which a polyether group is introduced to each of the terminals, side chain both and both terminal types in which a polyether group is introduced to each of the side chain and the terminals, ABn types in which a polyether-group-introduced polysiloxane (A) and an unintroduced polysiloxane (B) are repeatedly bonded, branched types in which polyether groups are introduced to branched terminals.

As the polyether-modified silicone compounds, the side chain (pendant) types in which a polyether group is introduced to a side chain of polysiloxane are preferably used. The side chain type polyether-modified silicone compounds are not particularly limited, and a silicone compound having the following formula (I) is preferably used in terms of not only decreasing surface tension of the ink but also preventing the ink from anchoring to nozzle plate of head.

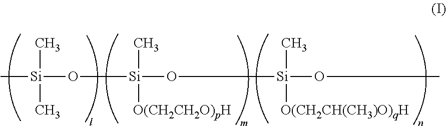

wherein l, m, n, p and q are integers, and l+m+n is not greater than 2,000 and p+q is not greater than 100.

As the silicone surfactants, marketed products can be used. Specific examples of the marketed products include KF-351A, KF-352A, KF-353 (Silicone surfactant having the formula (I)), KF-354L, KF-355A, KF-615A, KF-945, KF-618, KF-6011, KF-6015 and KF-6004 from Shin-Etsu Chemical Co., Ltd.; SF-3771, SF-8427, SF-8428, SH-3749, SH-8400, FZ-2101, FZ-2104, FZ-2118, FZ-2201, FZ-2101, FZ-2104, FZ-2118, FZ-2203, FZ-2207 and L-7604 from Dow Corning Toray Silicone Co., Ltd.; BYK-345, BYK-346 and BYK-348 from BYK-Chemie Japan; etc.

The black ink and the color ink preferably include the fluorine surfactant in an amount of from 0.1 to 3.0% by weight, and more preferably from 0.3 to 1.0% by weight in terms of better image density and discharge recovery.

The black ink and the color ink preferably include the silicone surfactant in an amount of from 0.05 to 3.0% by weight in terms of good discharge stability.

Specific examples of the other components include defoamers, pH control agents, anti-septic and anti-fungal agents, anti-corrosion agents, anti-oxidants, ultraviolet absorbers, etc.

Specific examples of the defoamers include silicone defoamers, polyether defoamers, fatty acid ester defoamers, etc.

The pH control agents are not particularly limited as long as they are capable of controlling pH to be not less than 7, and include diethanol amine, triethanol compounds, lithium carbonate, sodium carbonate, potassium carbonate, ammonium hydroxide, lithium hydroxide, sodium hydroxide, potassium hydroxide, etc.

Specific examples of the anti-septic and anti-fungal agents include, but are not limited, 1,2-benzisothiazolin-3-on, dehydrosodium acetate, sodium sorbinate, 2-pyridine thiol-1-oxide sodium, sodium benzoate, and pentachlorophenol sodium.

Specific examples of the anti-corrosion agents include, but are not limited to, acid sulfite, thiosodium sulfate, ammonium thiodiglycolate, diisopropyl ammonium nitrite, pentaerythritol quaternary nitride, and dicyclohexyl ammonium nitrite.

Specific examples of the anti-oxidants include, but are not limited to, phenol-based anti-oxidants (including hindered phenol-based anti-oxidants), amino-based anti-oxidants, sulfur-based anti-oxidants, and phosphorous-based anti-oxidants.

Specific examples of the ultraviolet absorbers include, but are not limited to, oxybenzone, phenyl salicylate, and paraaminobenzoate ester

The black ink and the color ink preferably has a viscosity of from 5.0 to 12.0 mPa·s at 25° C. The viscosity is measured by, e.g., a viscometer RE80L from TOKI SANGYO CO., LTD.

The inkjet recording method using the ink for inkjet recording of the present invention preferably includes at least an ink flight process of applying stimulation to the ink thorough an ink flyer to fly the ink from a recording head to record an image on recording media. Namely, the inkjet recording method using the ink for inkjet recording of the present invention includes at least an ink flight process and other processes selected when necessary such as a stimulation generation process and a control process.

The inkjet recorder of the present invention has an ink flight means flying the ink for inkjet recording of the present invention from a recording head to record an image on recoding media. Namely, the inkjet recorder of the present invention preferably includes at least a recording head and a maintenance and recovery device, and other means such as a stimulation generator and a controller when necessary.

Hereinafter, the inkjet recording method is explained through explanation of the inkjet recorder of the present invention.

The inkjet recorder applies a stimulation to each of the ink through an ink flight means to discharge the ink from a nozzle of the recording head to record an image. The stimulation is generated by, e.g., a stimulation generator. Specific examples of the stimulation include, but are not limited to, heat (temperature), pressure, oscillation and light. These can be used alone or in combination. Among these, heat and pressure are preferably used.

Specific examples of the stimulation generator include heater, pressurizer, piezo element, oscillator, ultrasonic oscillator, light, etc. For example, piezo actuator such as piezo element, thermal actuator using a phase variation due to film boiling of a liquid using electric heat conversion element such as heating resistant, shape-memory alloy actuator using metal phase variation due to variation of temperature, electrostatic actuator using electrostatic force are used.

The ink flight differs according to the stimulation. When the stimulation is heat, a heat energy according to a recording signal is applied from, e.g., a thermal head to the recording ink in a recording head. The heat energy has the recording ink generate bubbles. A pressure of the bubbles discharge the recording ink as a droplet from the nozzle of the recording head. When the stimulation is pressure, e.g., a voltage is applied to a piezo element bonded to a pressure room in an ink flow channel in the recording head. The piezo element bended and the pressure room decreases its capacity to discharge the recording ink as a droplet from the nozzle of the recording head.

The droplet of the ink preferably has a size of from 3 to 40 pl, a spray speed of from 5 to 20 m/s, a drive frequency not less than 1 kHz, and an image resolution not less than 300 dpi.

The recording head preferably includes many nozzles, and a head or a recording unit dripping and discharging the ink with energy. Further, the recording head preferably includes a liquid room, a fluid resistor, an oscillation plate and a nozzle member, and at least a part of the recording head is preferably formed of a material including silicone or nickel. The recording head preferably has a nozzle diameter not greater than 30 μm, and more preferably of from 1 to 20 μm.

The inkjet recorder of the present invention preferably has a sub-tank feeding ink on the recording head, which is filled with ink through a feed tube from an ink cartridge.

The maintenance and recovery device includes at least one suction cap connected with a suction generator, capping the recording head, and one moisturizing cap not connected with the suction generator, capping the recording head, and other means when necessary. The suction cap and the moisturizing cap decrease ink and time consumed for maintaining, and waste of ink more than when all the caps a re suction caps.

The maintenance and recovery device is not particularly limited, and one disclosed in Japanese published unexamined application No. JP-2005-170035-A can be used.

The inkjet recorder of the present invention preferably has a reverser reversing recording surfaces of recording media to be duplex printable. The reverser includes a transfer belt having electrostatic force, a recording media holder with air suction, a combination of a transfer roller and a spur, etc. Further, the inkjet recorder of the present invention preferably has an endless transfer belt and a transferer transferring recording media while holding them by the charged transfer belt. In this case, an AC bias of from ±1.2 to ±2.6 kV is preferably applied to a charging roller to charge the transfer belt.

The controller is not particularly limited as long as it is capable of controlling operation of each of the means, and includes a sequencer, a computer, etc.

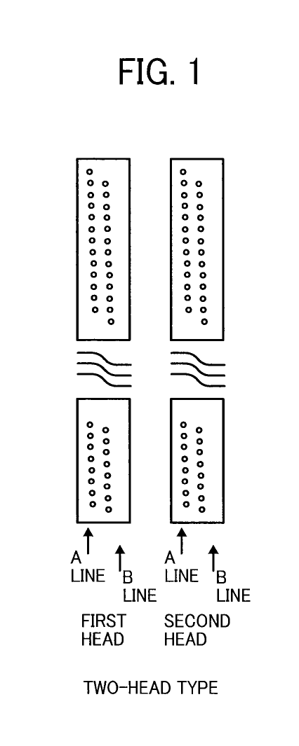

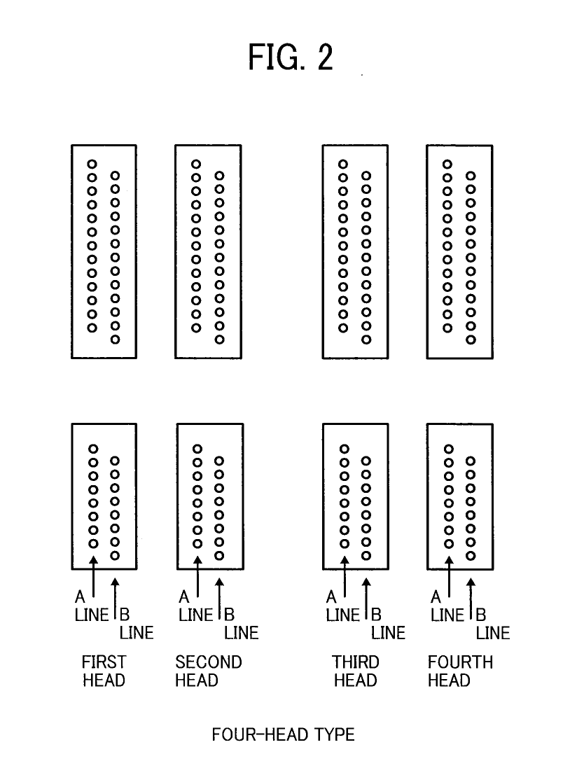

FIGS. 1 and 2 are schematic plain views illustrating embodiments of a recording head equipped in the inkjet recorder, seen from the nozzle surfaces. FIG. 1 is a two-head type formed of a first head and a second head. FIG. 2 is a four-head type formed of a first head, a second head, a third head and a fourth head.

In the two-head type, one of the first head and the second head is capped with a suction cap connected with a suction generator and the other is capped with a moisturizing cap not connected with the suction generator. In FIG. 1, the first head is capped with a suction cap and the second head is capped with a moisturizing cap.

In the four-head type in FIG. 2, at least one of the first to fourth heads is capped with a suction cap connected with a suction generator and the other are capped with moisturizing caps not connected with the suction generator. In FIG. 2, the first head is capped with a suction cap and the second, third and fourth heads are capped with moisturizing caps.

In the two-head type in FIG. 1, yellow (Y), cyan (C), magenta (M) and black (Bk) color inks need to be filled in four nozzle lines, respectively to record full-color images.

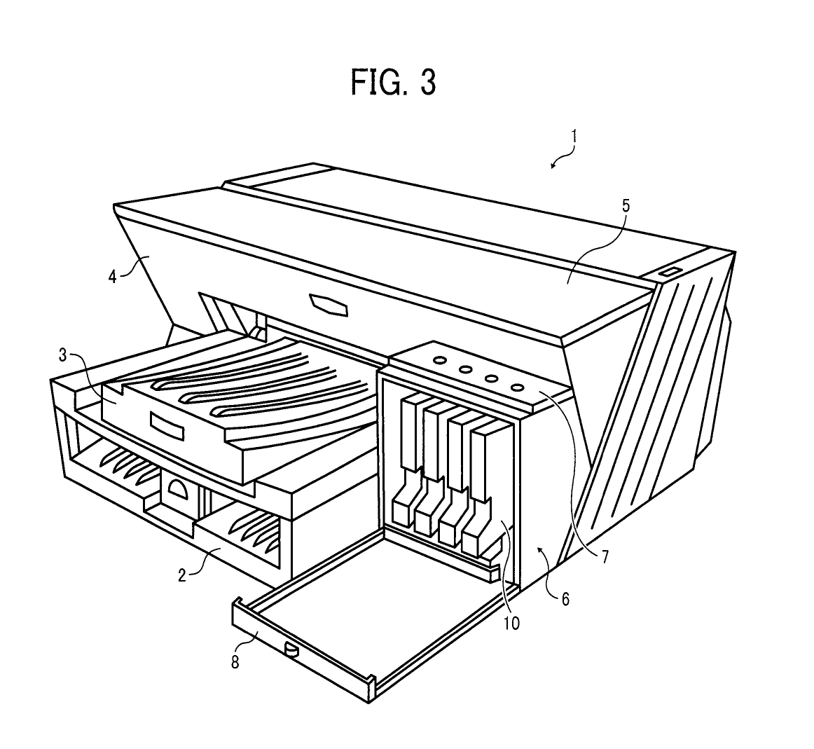

FIG. 3 is a perspective view illustrating an embodiment of the inkjet recorder having a maintenance and recovery device of the present invention. The inkjet recorder in FIG. 3 includes an apparatus 1, a paper feed tray 2 filled with papers and a paper discharge tray 3 on which recorded papers (media) are stocked. Further, the inkjet recorder includes a cartridge loader 6 at a side of a front surface 4, projecting forward therefrom and lower than an upper surface 5. Operation keys and a controller 7 are located on the upper surface of the cartridge loader 6. The cartridge loader 6 is loaded with an exchangeable main tank (ink container or ink cartridge) 10 which is a liquid reserve tank, and has an openable and closable front cover 8.

The ink cartridge includes a container containing the ink for inkjet recording of the present invention and may include other members when necessary. The container is not particularly limited in shape, structure, size and material, and an ink bag formed of aluminum laminated film or a resin film is preferably used.

An ink is filled in the ink bag from an ink inlet and the ink inlet is sealed with heat after the ink bag is degasified. The ink is fed through a needle inserted into an ink exhaust formed of a rubber. The ink bag is formed of a wrapper made of an air-impermeable aluminum laminated film, etc. The ink bag is typically contained in a plastic cartridge case detachable from various inkjet recorders.

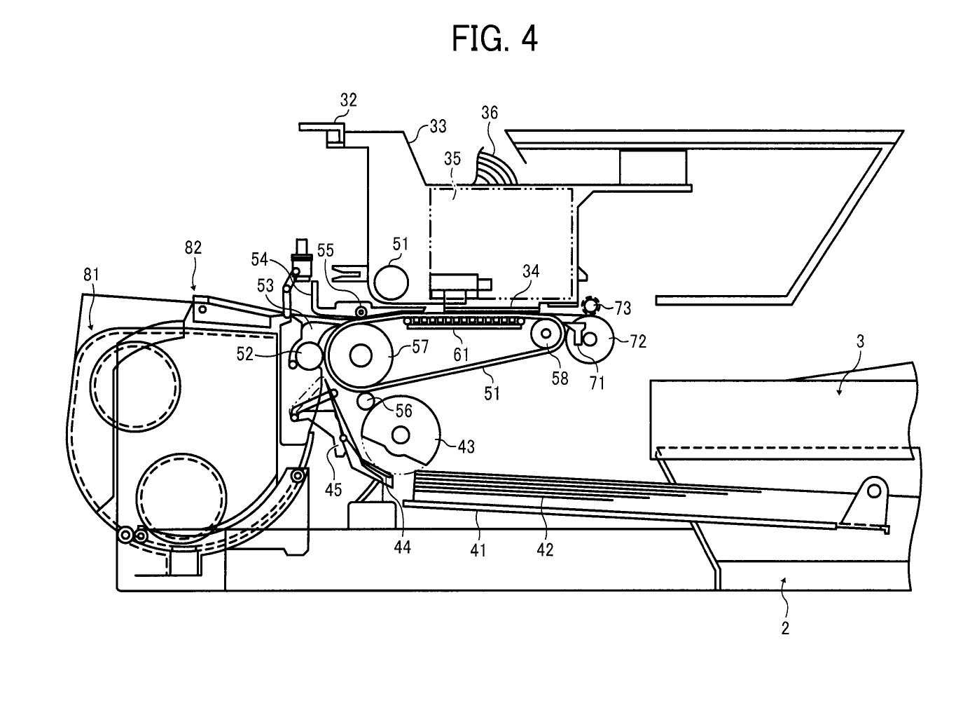

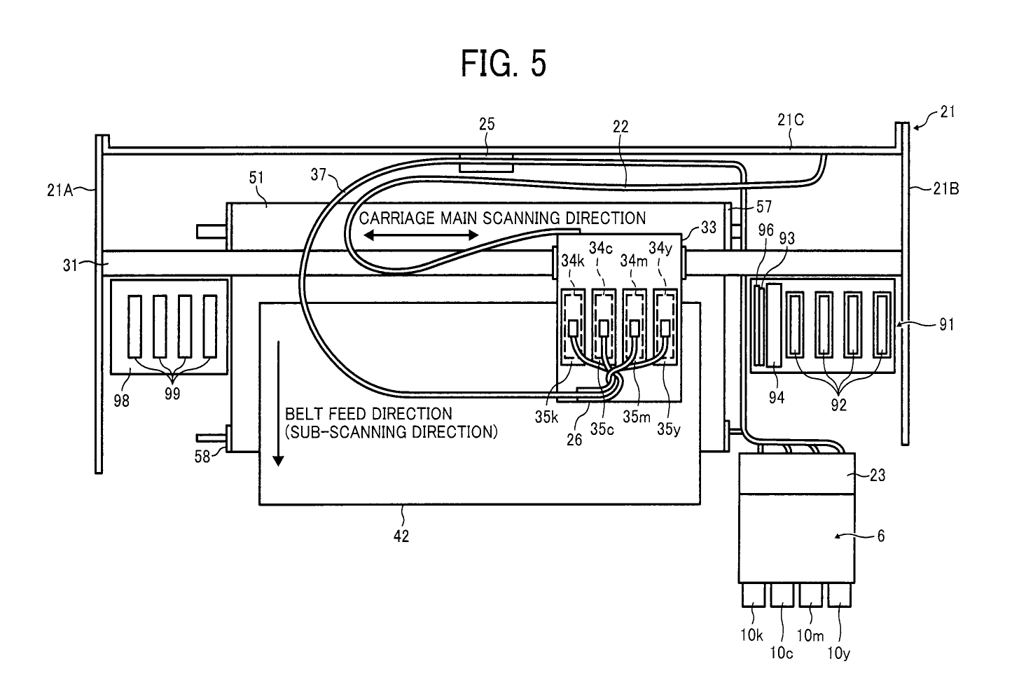

FIG. 4 is a schematic view illustrating an overall structure of the inkjet recorder in FIG. 3, and FIG. 5 is a schematic plain view illustrating a main part of the inkjet recorder therein.

A guide rod 31 as a guide member and a stay 32 horizontally suspended between side boards 21A and 21B forming a frame 21 slidably hold a carriage 33 in a main scanning direction, and a main scanning motor drives the carriage in the main scanning direction in FIG. 3.

The carriage 33 is loaded with plural recording heads 34 formed of inkjet heads which are droplet discharge heads discharging ink droplets, in which plural nozzles are located in a direction intersecting with the main scanning direction, directing the ink droplet discharge direction downward. The recording heads 34 includes a recording head 34y discharging a yellow (Y) droplet, a recording head 34c discharging a magenta (M) droplet, a recording head 34c discharging a cyan (C) droplet, and a recording head 34k discharging a black (Bk) droplet. Further, one or plural recording heads having one or plural nozzle lines discharging one or plural color droplets can also be used.

The droplet discharge head forming the recording head 34 includes those equipped with a piezoelectric actuator such as a piezoelectric element, a thermal actuator that utilizes the phase change caused by film boiling of liquid using an electric heat conversion element such as a heat element, a shape-memory alloy actuator that uses the metal phase change due to the temperature change, and an electrostatic actuator that uses an electrostatic force as an energy generator to discharge droplets.

The carriage 33 is loaded with sub-tanks 35y, 35m, 35c and 35k for feeding each color ink to each recording head 34. The sub-tank 35 is filled with each color ink from each ink cartridge 10y, 10m, 10c and 10k through each ink-feed tube 37.

The ink cartridge 10 is contained in the cartridge loader 6 as FIG. 5 shows. A feed pump unit 23 feeding ink in the ink cartridge 10 is located in the cartridge loader 6. The ink-feed tube 37 from the cartridge loader 6 to the sub-tank 35 is fixedly held by a holder 25 on a back board 21C forming the frame 21 on the way of being laid.

In FIGS. 4 and 5, 22 is a flexible cable and 36 is an ink-feed tube (sub-tank connector).

As a paper feeder feeding papers 42 loaded on a paper loader (bottom board) 41 of the paper feed tray 2, a semicircular (paper feed) roller 43 and a separation pad 44 formed of a material having a large friction coefficient separating and feeding one by one of the papers 42 from the paper loader 41 are equipped. The separation pad 44 is biased to the paper feed roller 43.

In addition, a transfer belt 51 electrostatically adsorbing a paper 42 and transferring the paper as a transferer transferring the paper 42 fed from the paper feeder below the recording head 34, a counter roller 52 sandwiching the paper 42 fed from the paper feeder through a guide 45 with the transfer belt 51 and transferring the paper, a transfer guide 53 changing the paper 42 fed almost vertically in direction at 90° to place the paper 42 on the transfer belt 51, a head pressure roller 55 biased to the transfer belt 51 by a pressure member 54 are equipped. Further, a charging roller 56 charging the surface of the transfer belt 51 is equipped.

The transfer belt 51 is an endless belt suspended with tension between a transfer roller 57 and a tension roller 58 and is rotated in a belt transfer direction in FIG. 10. A charging roller 56 contacts a surface layer of the transfer belt 51 and rotates in company with rotation of the transfer belt 51, and a pressure of 2.5N is applied to each of both ends of an axis thereof.

On the back of the transfer belt 51, a guide member 61 is located according to a printing area of the recording head 34. The guide member 61 projects more than a tangent line of the two rollers supporting the transfer belt 51 (transfer roller 57 and the tension roller 58) to the recording head 34. Thus, the transfer belt 51 is pressed up and guided by the upper surface of the guide member 61 to maintain high-precision flatness.

Further, to discharge the paper 42 recorded by the recording head 34, a separation claw 71 separating the paper 42 from the transfer belt 51, paper discharge rollers 72 and 73 are equipped, and a paper discharge tray 3 is equipped below the paper discharge roller 72. A distance from the paper discharge rollers 72 and 73 to the paper discharge tray 3 is long to some extent to stock as many papers as possible.

A both-side paper feed unit 81 is detachably installed on the back of the apparatus 1. The both-side paper feed unit 81 reverses the paper 42 retuned by reverse rotation of the transfer belt 51 and feeds the paper between a counter roller 52 and the transfer belt 51 again. A manual paper feeder 82 is located on the upper surface of the both-side paper feed unit 81.

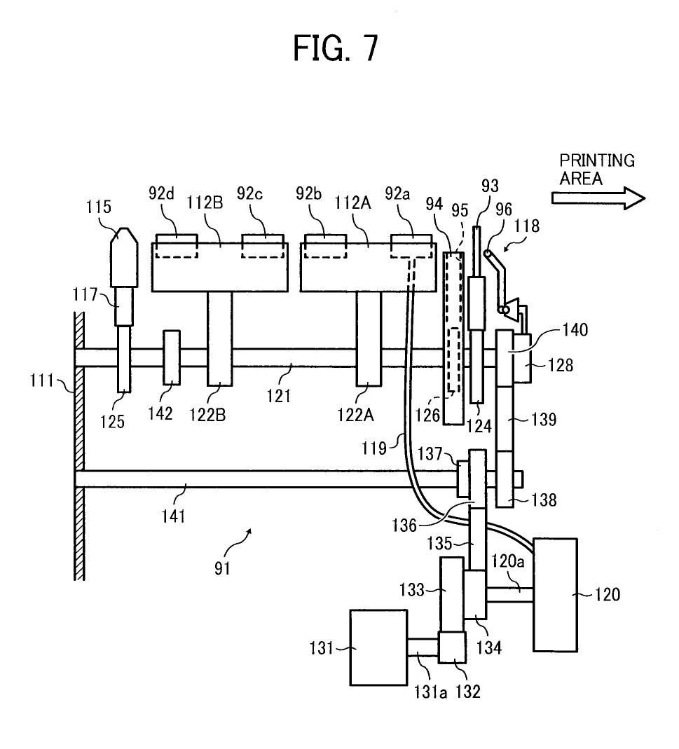

Further, as FIG. 5 shows, in a non-printing area at one side of the scanning direction of the carriage 33, a maintenance and recovery device (sub-system) 91 maintaining and recovering the nozzles of the recording head 34. The subsystem 91 includes cap members (caps) 92a to 92d capping the nozzle surfaces of the recording head 34, a wiper blade 93 which is a blade member wiping the nozzle surfaces, a blank discharge receiver 94 receiving droplets not for recording of blank discharge to discharge thickened ink, a wiper cleaner 95 (FIG. 7) removing ink adhering to the wiper blade 93, which is united with the blank discharge receiver 94, and a cleaner roller 96 pressing the wiper blade 93 to the wiper cleaner 95 when the wiper blade 93 is cleaned.

As FIG. 5 shows, in a non-printing area at the other side of the scanning direction of the carriage 33, a blank discharge receiver 98 receiving droplets not for recording of blank discharge to discharge thickened ink is located, and the discharge receiver 98 has an opening 99 along nozzle line direction of the recording head 34.

In the inkjet recorder, the papers 42 are separately fed one by one from the paper feed tray 2, and the paper 42 fed upward almost vertically is guided by the guide 45 to be fed while sandwiched between the counter roller 52 and the transfer belt 51. Further, the end of the paper 42 is guided by the transfer guide 53 and is pressed against the transfer belt 51 by the head pressure roller 55 to be fed in a direction at an almost 90° turn.

Then, a control circuit applies an alternating voltage repeating positive and negative outputs alternately to the charging roller 56 from a high-voltage electric source, and the transfer belt 51 is zonally and alternately charged positively and negatively in a sub-scanning direction. When the paper 42 is fed onto the positively and negatively charged transfer belt 51, the paper 42 is electrostatically adsorbed to the transfer belt 51, and the paper 42 is fed in a sub-scanning direction by rotation of the transfer belt 51. The recording head 34 is driven according to an image signal while the carriage 33 is moved to discharge ink to the paper 42 and record one line thereon. After the paper 42 is transferred for a predetermined distance, the following line is recorded. Receiving a record finish signal or a signal representing a tail end of the paper 42 reaches the recording area, recording operation is finished and the paper 42 is discharged on the paper feed tray 3.

When ready to print, the carriage 33 is moved to the subsystem 91, the recording head is capped with the cap member 92 to moisturize the nozzle to prevent defective discharge due to dried ink. The cap member 92 caps the recording head 34 to suction ink from the nozzle to perform recovery operation discharging thickened ink and bubbles. Before and while recording, blank discharge of the ink not recording is performed. This maintains stable dischargeability of the recording head 34.

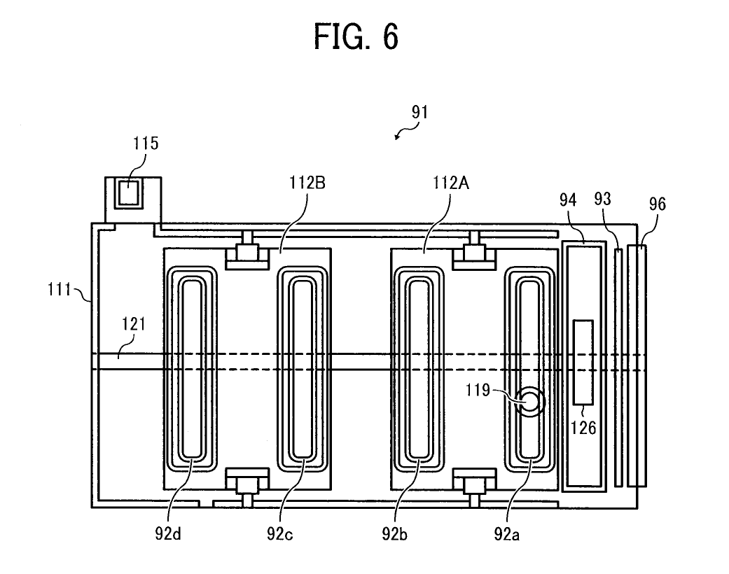

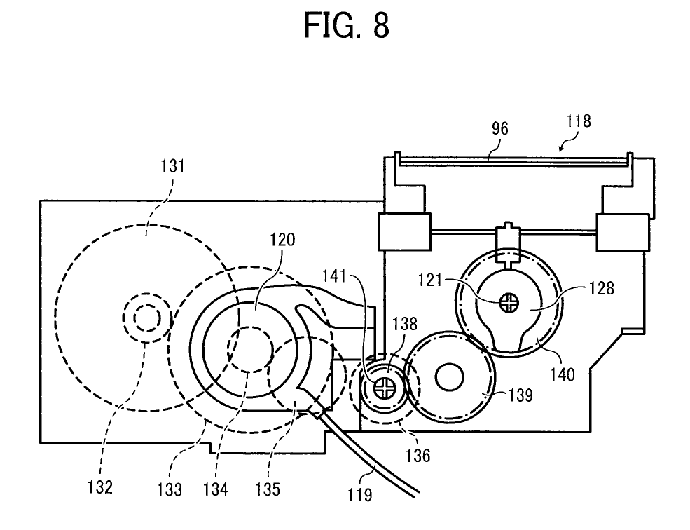

FIG. 6 is a schematic plain view illustrating a main part of a subsystem 91 including the maintenance and recovery device (subsystem 91) in the inkjet recorder of the present invention. FIG. 7 is a schematic view illustrating the subsystem in FIG. 6. FIG. 8 is a schematic view illustrating the right side of the subsystem in FIG. 6.

A frame 111 of the subsystem 91 holds two cap holders 112A and 112B holding the cap, a wiper blade 93 which is a wiping member including an elastic body as a cleaner, and a carriage lock 115, which are all vertically movable. A blank discharge receiver 94 is located between the wiper blade 93 and the cap holder 112A. To clean the wiper blade 93, a wiper cleaner 118 including a cleaner roller 96 pressing the wiper blade 93 to a wiper cleaner 95 cleaning the blank discharge receiver 94 from the outside is swingably held.

The cap holders 112A and 112B hold two caps 92a and 92b, and 92c and 92d capping the nozzle surface of two recording heads 34, respectively.

A tubing (suction) pump 120 is connected with the cap 92a held by the cap holder 112A through a flexible tube 119, and the tubing pump 120 is connected with each of the other caps 92b, 92c and 92d. Namely, only the cap 92a is a suction (recovery) and moisturizing cap and each of the other caps 92b, 92c and 92d is simply a moisturizing cap. Therefore, when recovery operation of the recording head 34 is performed, the recording head 34 is selectively moved to a position where it can be capped by the cap 92a.

Below the cap holders 112A and 112B, a cam shaft 121 is rotatably supported by the frame 111. The cam shaft 121 includes cap cams 122A and 122B elevating the cap holders 112A and 112B, a wiper cam 124 elevating the wiper blade 93, a carriage lock cam 125 elevating the carriage lock 115 through a carriage lock arm 117, a roller 126 droplets discharged in the blank discharge receiver 94 land on, and a cleaner cam 128 swinging the wiper cleaner 118.

The cap 92 is elevated by the cap cams 122A and 122B. The wiper blade 93 is elevated by the wiper cam 124. When the wiper blade 93 descends while the wiper cleaner 118 come out to be sandwiched between the cleaner roller 96 of the wiper cleaner 118 and the wiper cleaner 95 of the blank discharge receiver 94, ink adhering to the wiper blade 93 is scraped off in the blank discharge receiver 94.

The carriage lock 115 is biases upward (lock direction) by a compressed spring to be elevated through the carriage lock arm 117 driven by the carriage lock cam 125. In order to rotate the tubing pump 120 and the cam shaft 121, a pump gear 133 formed on a pump shaft of the tubing pump 120 is engaged with a motor gear 132 formed on a motor shaft 131a of a motor 131. Further, an intermediate gear 136 having a one-direction clutch is engaged with an intermediate gear 134 united with the pump gear 133 through an intermediate gear 135. A cam gear 140 fixed on the cam shaft 121 is engaged with an intermediate gear 138 having the same shaft as that of the intermediate gear 136. An intermediate shaft 141 which is a rotational shaft of the intermediate gear 136 having a clutch 137 and the intermediate gear 138 is rotatably held by the frame 111.

The subsystem 91 has a home position sensor cam 142 detecting a home position. The home position sensor operates a home position lever when the cap 92 comes to the lowest end and the sensor is open to detect a home position of the motor 131 (except for the pump 120. When the power is on, the cap 92 (cap holder 112) elevates regardless of its position and does not detection the position until starts moving. After the cap 92 detects the home position (while ascending), the cap 92 moves for a fixed distance to lowest end. Then, the carriage moves right and left and returns to a cap position after detecting the position, and the recording head 34 is capped.

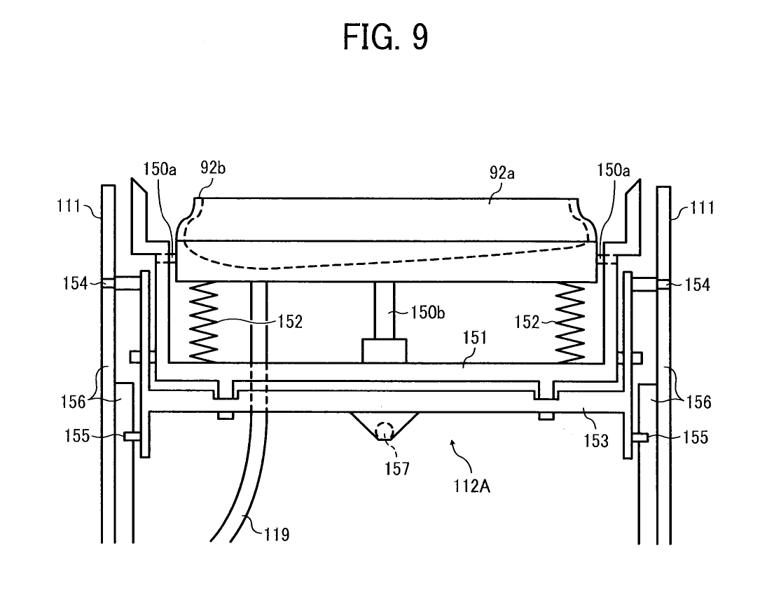

FIG. 9 is a schematic view illustrating a side of holding and elevating mechanism of the cap 92.

A cap holder 112A holding a cap has a holder 151 elevatably holding the caps 92a and 92b (92A), a spring 152 located between a bottom surface of the holder 151 and a bottom of the cap 92A, biasing the cap 92A upward, and a slider 153 slidably holding the holder 151 back and forth (line direction of the nozzles of the recording head 34).

The cap 92A is equipped with guide pins 150a at both ends elevatable through an unillustrated guide trough of the holder 151 and a guide shaft 150b at the bottom surface elevatably on the holder 151. A spring 152 located between the cap 92A and the cap holder 151 biases the caps 92a and 92b upward (a direction of pressing the caps 92a and 92b to the nozzle surfaces when capped).

The slider 153 slidably engages the guide pins 154 and 155 with a guide trough 156 formed on the frame 111 such that the slider 153, the holder 151 and the cap 92A are all elevatable. A cam pin 157 located below the slider 153 is engaged with an unillustrated cam through to elevate the slider 153, the holder 151 and the cap 92A by rotation of the cap cam 122A rotating with the cam shaft 121 rotation of the motor 131 is transmitted to. Further, the slider 153 and the holder 151 are inserted into the suction cap 92a, a tube 119 is wired thereon in its short direction from the lower part of the central position o the cap.

A cap holder 112B holding the caps 92c and 92d (cap 92B) and a method of elevating this are same as above. However, the tube 119 is not connected to the caps 92c and 92d. The motor 131 is driven to rotate the cam shaft 121, and the cam shaft 121 rotates to rotate the cams 122A and 122B fixed thereon such that the caps 92A and 92B elevate.

The inkjet recorder and the inkjet recording method of the present invention are used for various inkjet recordings such as inkjet recording printers, facsimiles, copiers and their combination machines.

The recorded matter of the present invention has an image recorded by the inkjet ink of the present invention on a recording medium and has high-quality images and good stability preferably usable for various applications.

The recording media are not particularly limited, as long as the inkjet recording ink of the present invention lands thereon to form an image thereon. Specific examples thereof include plain papers, coated papers for printing, glossy papers, special papers, etc. They include calcium carbonate, talc, kaolin or aluminum sulfate, etc., and divalent or trivalent ions such as calcium, magnesium and aluminum elute when the inkjet recording ink of the present invention lands thereon. Namely, the ink of the present invention reacts with the metallic ions to agglutinate a pigment and produces images having high image density.

Most of loading materials and size fixers included in the plain papers are metallic salts having poor water solubility. Even when a water-soluble metallic salt is included, the content there of is low. Therefore, the plain papers do not improve in image density so much as papers including water-soluble multivalent metallic salts.

However, the inkjet recording ink of the present invention reacts with a pigment to produce images having high image density even when the multivalent metallic ions elute less.

Specific examples of the marketed plain papers include quality paper My Paper from Ricoh Company, Ltd., Xerox 4024 from Fuji Xerox Co., Ltd., etc.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### Synthesis Example 1 of Copolymer Including a Salt of Phosphonic Acid Group

In a reaction container including a gas inlet tube, a thermometer and a reflux condenser, in an argon atmosphere, 400 parts of methyl ethyl ketone, 25 parts of vinyl phosphate from Tokyo Chemical Industry Co., Ltd., 75 parts of styrene from Tokyo Chemical Industry Co., Ltd., and 5 parts of 1-dodecanthiol as a molecular weight adjuster from Tokyo Chemical Industry Co., Ltd. were placed to prepare a solution, and argon gas displacement was performed for 30 min while the solution was stirred to prepare a mixed solution. In an argon atmosphere, the mixed solution was heated to have a temperature of 60° C. while stirred, and a solution including a half of 6 parts of a polymerization initiator 2,2′-azobis(2,4-dimethylvaleronitrile) and methyl ethyl ketone was dripped therein with a dripping funnel. After dripped, the temperature of the mixed liquid was maintained at 60° C. for 12 hrs. Then, the remaining solution of the polymerization initiator was dripped and reacted at 75° C. for 2 hrs to prepare a copolymer solution. The copolymer solution was placed in a large amount of n-hexane to precipitate the copolymer and a solvent was removed therefrom by decantation. Further, the precipitated product was dried to prepare a copolymer including a phosphonic acid group. The copolymer was subjected to GPC measurement using tetrahydrofuran as a solvent and polystyrene as a standard material.

The copolymer was dissolved in ethanol to prepare a solution, and potassium hydroxide dissolved in methanol was added and mixed therein so as to be completely disacidified. After the mixture was stirred, a solvent was removed by an evaporator, and further dried in a vacuum to prepare a copolymer R1 having a neutralized phosphonic acid group. Structural properties and a weight-average molecular weight (Mw) of the copolymer R1 are shown in Table 2.

### Synthesis Example 2 to 23 of Copolymer Including a Salt of Phosphonic Acid Group

The procedure for preparation of the copolymer including a salt of phosphonic acid group in Synthesis Example 1 was repeated except for changing a compositional ratio of the vinyl phosphonic acid to the diacetone acrylic amide of from 15/85 to 65/35, changing the amount of the molecular weight adjuster from 0 to 6 parts by weight, changing the amount of the polymerization initiator from 3 to 10 parts by weight. Further, sodium hydroxide, potassium hydroxide, triethanol amine, trimethyl amine, diethanol amine and triethyl amine were used as the neutralizer such that neutralization rates were from 80 to 100% to prepare copolymers R-2 to R-23 each having a neutralized phosphonic acid group. The results are shown in Table 2.

TABLE 2

| Copolymer | | | Hydrogen atom | |
|---|---|---|---|---|
| including a | Combination | Formula (1) | content rate | |
| phosphonic | No. in formula | content rate (% | in formula | |
| acid group | (1) | by weight) | (1) (% by mol) | Mw |
| R1-1 | 1-3 | 25 | — | 1600 |
| R1-2 | 1-3 | 15 | — | 3200 |
| R1-3 | 1-3 | 25 | — | 2700 |
| R1-4 | 1-3 | 55 | — | 1700 |
| R1-5 | 1-3 | 65 | — | 2600 |
| R1-6 | 1-3 | 55 | — | 3100 |
| R1-7 | 1-3 | 55 | — | 35000 |
| R1-8 | 1-3 | 65 | — | 26000 |
| R1-9 | 1-3 | 55 | — | 24000 |
| R1-10 | 1-3 | 25 | — | 34000 |
| R1-11 | 1-3 | 15 | — | 26000 |
| R1-12 | 1-3 | 25 | — | 22000 |
| R1-13 | 1-3 | 35 | — | 2700 |
| R1-14 | 1-3 | 35 | — | 1700 |
| R1-15 | 1-3 | 35 | — | 27000 |
| R1-16 | 1-3 | 35 | — | 38000 |
| R1-17 | 1-3 | 15 | — | 1500 |
| R1-18 | 1-3 | 65 | — | 41000 |
| R1-19 | 1-4 | 35 | 10 | 3500 |
| R1-20 | 1-4 | 35 | 20 | 3200 |
| R1-21 | 1-1 | 35 | — | 3100 |
| R1-22 | 1-7 | 35 | — | 3400 |
| R1-23 | 1-8 | 35 | 10 | 3600 |

### Synthesis Example of Copolymer R-100 Including Phosphoric Acid Group

With reference to a synthesis example in Japanese published unexamined application No. JP-2011-122072-A, 30 parts of styrene, 20 parts of methylmethacrylate, 15 parts of butylmethacrylate, 10 parts of methacrylate, 20 parts of phosmer M (monomer including a phosphoric acid group from Uni-Chemical Co., Ltd.) and 5 parts of azobisisobutylonitrile were polymerized to prepare a copolymer R-100 including a phosphoric acid group. The copolymer had a weight-average molecular weight of 6700.

### Pigment Dispersion Preparation Examples 1 to 33

Each of materials of pigment dispersions 1 to 33 in Tables 3-1 to 3-3 were premixed to prepare a mixed slurry. For examples, pigment dispersion 1 was a mixture of 2 parts of R-13, 16 parts of carbon black and 82 parts of high-purity water. This was subjected to a circulation dispersion by a disc type media mill (DMR from Ashizawa Finetech Ltd.) with 0.05 mm zirconia beads at a filling rate of 55%, a peripheral speed of 10 m/s, a liquid temperature of 10° C. for 3 min. Then, the resultant dispersion was subjected to centrifugal separation by a centrifugal separator Model 7700 from KUBOTA Corporation to separate coarse particles to prepare a pigment dispersion 1-1 having a pigment concentration of 16% by weight.

The numbers in Tables 3-1 to 3-5 are parts by weight.

NIPEX160 is from Degussa AG, and has a BET specific surface area of 150 m²/g, an average primary particle diameter of 20 nm, a pH of 4.0 and a DBP oil absorption of 620 g/100 g.

RT-100 is POE (m=40) β-naphthylether.

TABLE 3-1

| | | Pigment Dispersion | | | | |
|---|---|---|---|---|---|---|
| | | 1 | 2 | 3 | 4 | 5 |
| R-1 | | | | | | |
| R-2 | | | | | | |
| R-3 | | | | | | |
| R-4 | | | | | | |
| R-5 | | | | | | |
| R-6 | | | | | | |
| R-7 | | | | | | |
| R-8 | | | | | | |
| R-9 | | | | | | |
| R-10 | | | | | | |
| R-11 | | | | | | |
| R-12 | | | | | | |
| R-13 | | 2 | 4 | 16 | 4 | 4 |
| R-14 | | | | | | |
| R-15 | | | | | | |
| R-16 | | | | | | |
| R-17 | | | | | | |
| R-18 | | | | | | |
| R-19 | | | | | | |
| R-20 | | | | | | |
| R-21 | | | | | | |
| R-22 | | | | | | |
| R-23 | | | | | | |
| R-100 | | | | | | |
| Dispersant | RT-100 | | | | | |
| (Surfactant) | | | | | | |
| Carbon | NIPEX160 | 16 | 16 | 16 | | |
| black | | | | | | |
| Pigment | CHROMOFINE | | | | 16 | |
| Blue 15:3 | BLUE A-220JC | | | | | |
| | (DAINICHISEIKA) | | | | | |
| Pigment | Toner Magenta | | | | | 16 |
| Red 122 | EO02 (Clariant) | | | | | |
| Pigment | Fast Yellow 531 | | | | | |
| Yellow 74 | (DAINICHISEIKA) | | | | | |
| Solvent | High-purity water | Bal- | Bal- | Bal- | Bal- | Balance |
| | | ance | ance | ance | ance | |

| | | | | | |
|---|---|---|---|---|---|
| Total | 100 | 100 | 100 | 100 | 100 |

TABLE 3-2

| | | Pigment Dispersion | | | | | | | |
|---|---|---|---|---|---|---|---|---|---|
| | | 6 | 7 | 8 | 9 | 10 | 11 | 12 | 13 |
| R-1 | | | | | | | 4 | | |
| R-2 | | | | | | | | 4 | |
| R-3 | | | | | | | | | 4 |
| R-4 | | | | | | | | | |
| R-5 | | | | | | | | | |
| R-6 | | | | | | | | | |
| R-7 | | | | | | | | | |
| R-8 | | | | | | | | | |
| R-9 | | | | | | | | | |
| R-10 | | | | | | | | | |
| R-11 | | | | | | | | | |
| R-12 | | | | | | | | | |
| R-13 | | | 4 | | | | | | |
| R-14 | | | | | | | | | |
| R-15 | | | | | | | | | |
| R-16 | | | | | | | | | |
| R-17 | | | | | | | | | |
| R-18 | | | | | | | | | |
| R-19 | | | | | | | | | |
| R-20 | | | | | | | | | |
| R-21 | | | | | | | | | |
| R-22 | | | | | | | | | |
| R-23 | | | | | | | | | |
| R-100 | | | | 4 | 4 | 4 | 4 | | |
| Dispersant | RT-100 | | | | | | | | |
| (Surfactant) | | | | | | | | | |
| Carbon | NIPEX160 | | 16 | | | | 16 | 16 | 16 |
| black | | | | | | | | | |
| Pigment | CHROMOFINE | | | 16 | | | | | |
| Blue 15:3 | BLUE A-220JC | | | | | | | | |
| | (DAINICHISEIKA) | | | | | | | | |
| Pigment | Toner Magenta | | | | 16 | | | | |
| Red 122 | EO02 (Clariant) | | | | | | | | |
| Pigment | Fast Yellow 531 | 16 | | | | 16 | | | |
| Yellow 74 | (DAINICHISEIKA) | | | | | | | | |
| Solvent | High-purity water | Balance | Balance | Balance | Balance | Balance | Balance | Balance | Balance |

| | | | | | | | | |
|---|---|---|---|---|---|---|---|---|
| Total | 100 | 100 | 100 | 100 | 100 | 100 | 100 | 100 |

TABLE 3-3

| | | Pigment Dispersion | | | | | | | |
|---|---|---|---|---|---|---|---|---|---|
| | | 14 | 15 | 16 | 17 | 18 | 19 | 20 | 21 |
| R-1 | | | | | | | | | |
| R-2 | | | | | | | | | |
| R-3 | | | | | | | | | |
| R-4 | | 4 | | | | | | | |
| R-5 | | | 4 | | | | | | |
| R-6 | | | | 4 | | | | | |
| R-7 | | | | | 4 | | | | |
| R-8 | | | | | | 4 | | | |
| R-9 | | | | | | | 4 | | |
| R-10 | | | | | | | | 4 | |
| R-11 | | | | | | | | | 4 |
| R-12 | | | | | | | | | |
| R-13 | | | | | | | | | |
| R-14 | | | | | | | | | |
| R-15 | | | | | | | | | |
| R-16 | | | | | | | | | |
| R-17 | | | | | | | | | |
| R-18 | | | | | | | | | |
| R-19 | | | | | | | | | |
| R-20 | | | | | | | | | |
| R-21 | | | | | | | | | |
| R-22 | | | | | | | | | |
| R-23 | | | | | | | | | |
| R-100 | | | | | | | | | |
| Dispersant | RT-100 | | | | | | | | |
| (Surfactant) | | | | | | | | | |
| Carbon | NIPEX160 | 16 | 16 | 16 | 16 | 16 | 16 | 16 | 16 |
| black | | | | | | | | | |
| Pigment | CHROMOFINE | | | | | | | | |
| Blue 15:3 | BLUE A-220JC | | | | | | | | |
| | (DAINICHISEIKA) | | | | | | | | |
| Pigment | Toner Magenta | | | | | | | | |
| Red 122 | EO02 (Clariant) | | | | | | | | |
| Pigment | Fast Yellow 531 | | | | | | | | |
| Yellow 74 | (DAINICHISEIKA) | | | | | | | | |
| Solvent | High-purity water | Balance | Balance | Balance | Balance | Balance | Balance | Balance | Balance |

| | | | | | | | | |
|---|---|---|---|---|---|---|---|---|
| Total | 100 | 100 | 100 | 100 | 100 | 100 | 100 | 100 |

TABLE 3-4

| | | Pigment Dispersion | | | | | | | |
|---|---|---|---|---|---|---|---|---|---|
| | | 22 | 23 | 24 | 25 | 26 | 27 | 28 | 29 |
| R-1 | | | | | | | | | |
| R-2 | | | | | | | | | |
| R-3 | | | | | | | | | |
| R-4 | | | | | | | | | |
| R-5 | | | | | | | | | |
| R-6 | | | | | | | | | |
| R-7 | | | | | | | | | |
| R-8 | | | | | | | | | |
| R-9 | | | | | | | | | |
| R-10 | | | | | | | | | |
| R-11 | | | | | | | | | |
| R-12 | | 4 | | | | | | | |
| R-13 | | | 4 | | | | | | |
| R-14 | | | | 4 | | | | | |
| R-15 | | | | | 4 | | | | |
| R-16 | | | | | | 4 | | | |
| R-17 | | | | | | | 4 | | |
| R-18 | | | | | | | | 4 | |
| R-19 | | | | | | | | | 4 |
| R-20 | | | | | | | | | |
| R-21 | | | | | | | | | |
| R-22 | | | | | | | | | |
| R-23 | | | | | | | | | |
| R-100 | | | | | | | | | |
| Dispersant | RT-100 | | | | | | | | |
| (Surfactant) | | | | | | | | | |
| Carbon | NIPEX160 | 16 | 16 | 16 | 16 | 16 | 16 | 16 | 16 |
| black | | | | | | | | | |
| Pigment | CHROMOFINE | | | | | | | | |
| Blue 15:3 | BLUE A-220JC | | | | | | | | |
| | (DAINICHISEIKA) | | | | | | | | |
| Pigment | Toner Magenta | | | | | | | | |
| Red 122 | EO02 (Clariant) | | | | | | | | |
| Pigment | Fast Yellow 531 | | | | | | | | |
| Yellow 74 | (DAINICHISEIKA) | | | | | | | | |
| Solvent | High-purity water | Balance | Balance | Balance | Balance | Balance | Balance | Balance | Balance |

| | | | | | | | | |
|---|---|---|---|---|---|---|---|---|
| Total | 100 | 100 | 100 | 100 | 100 | 100 | 100 | 100 |

TABLE 3-5

| | | Pigment Dispersion | | | |
|---|---|---|---|---|---|
| | | 30 | 31 | 32 | 33 |
| R-1 | | | | | |
| R-2 | | | | | |
| R-3 | | | | | |
| R-4 | | | | | |
| R-5 | | | | | |
| R-6 | | | | | |
| R-7 | | | | | |
| R-8 | | | | | |
| R-9 | | | | | |
| R-10 | | | | | |
| R-11 | | | | | |
| R-12 | | | | | |
| R-13 | | | | | |
| R-14 | | | | | |
| R-15 | | | | | |
| R-16 | | | | | |
| R-17 | | | | | |
| R-18 | | | | | |
| R-19 | | | | | |
| R-20 | | 4 | | | |
| R-21 | | | 4 | | |
| R-22 | | | | 4 | |
| R-23 | | | | | 4 |
| R-100 | | | | | |
| Dispersant | RT-100 | | | | |
| (Surfactant) | | | | | |
| Carbon | NIPEX160 | 16 | 16 | 16 | 16 |
| black | | | | | |
| Pigment | CHROMOFINE | | | | |
| Blue 15:3 | BLUE A-220JC | | | | |
| | (DAINICHISEIKA) | | | | |
| Pigment | Toner Magenta | | | | |
| Red 122 | EO02 (Clariant) | | | | |
| Pigment | Fast Yellow 531 | | | | |
| Yellow 74 | (DAINICHISEIKA) | | | | |
| Solvent | High-purity water | Balance | Balance | Balance | Balance |

| | | | | |
|---|---|---|---|---|
| Total | 100 | 100 | 100 | 100 |

### Examples 1 to 31 and Comparative Examples 1 to 5

Materials shown in Tables 4-1 to 4- were mixed and stirred for 1 hr to be uniformly mixed. The resultant dispersion was subjected to pressure filtration by a polyvinylidenefluoride membrane filter having an average pore diameter of 5.0 μm to remove coarse particles and dusts. Thus, a recording ink was prepared.

The numbers are % by weight.

| | | | TABLES 4-1 | | |
|---|---|---|---|---|---|
| | | | Example | | |
| | | | 1 | 2 | 3 |
| Pigment | Pigment dispersion 1 | R3-4-16/2_Bk | 50 | | |
| Dispersion | Pigment dispersion 2 | R3-4-16/4_Bk | | 50 | 50 |
| | Pigment dispersion 3 | R3-4-16/16_Bk | | | |
| | Pigment dispersion 4 | R3-4-16/4_Cy | | | |
| | Pigment dispersion 5 | R3-4-16/4_Ma | | | |
| | Pigment dispersion 6 | R3-4-16/4_Ye | | | |
| | Pigment dispersion 7 | RT-100_Bk | | | |
| | Pigment dispersion 8 | RT-100_Cy | | | |
| | Pigment dispersion 9 | RT-100_Ma | | | |
| | Pigment dispersion 10 | RT-100_Ye | | | |
| | Pigment dispersion 11 | R3-1-16/4_Bk | | | |
| | Pigment dispersion 12 | R3-2-16/4_Bk | | | |
| | Pigment dispersion 13 | R3-3-16/4_Bk | | | |
| | Pigment dispersion 14 | R3-4-16/4_Bk | | | |
| | Pigment dispersion 15 | R3-5-16/4_Bk | | | |
| | Pigment dispersion 16 | R3-6-16/4_Bk | | | |
| | Pigment dispersion 17 | R3-7-16/4_Bk | | | |
| | Pigment dispersion 18 | R3-8-16/4_Bk | | | |
| | Pigment dispersion 19 | R3-9-16/4_Bk | | | |
| | Pigment dispersion 20 | R3-10-16/4_Bk | | | |
| | Pigment dispersion 21 | R3-11-16/4_Bk | | | |
| | Pigment dispersion 22 | R3-12-16/4_Bk | | | |
| | Pigment dispersion 23 | R3-14-16/4_Bk | | | |
| | Pigment dispersion 24 | R3-15-16/4_Bk | | | |
| | Pigment dispersion 25 | R3-16-16/4_Bk | | | |
| | Pigment dispersion 26 | R3-17-16/4_Bk | | | |
| | Pigment dispersion 27 | R3-18-16/4_Bk | | | |
| | Pigment dispersion 28 | R3-19-16/4_Bk | | | |
| | Pigment dispersion 29 | R3-20-16/4_Bk | | | |
| | Pigment dispersion 30 | R3-21-16/4_Bk | | | |
| | Pigment dispersion 31 | R3-22-16/4_Bk | | | |
| | Pigment dispersion 32 | R3-23-16/4_Bk | | | |
| | Pigment dispersion 33 | R-100-16/4_Bk | | | |
| Additive | R-13 | | | | |
| Water- | Glycerin | 10 | 10 | 10 | |
| soluble | 1,3-butanediol | 20 | 20 | 20 | 30 |
| solvent | Trimethylol propane | | | | |
| | 2-pyrrolidone | | | | |
| Solvent | High-purity water | Balance | Balance | Balance | Balance |
| | Total | 100 | 100 | 100 | 100 |

TABLE 4-2

| | | Example | | | | | | | |
|---|---|---|---|---|---|---|---|---|---|
| | | 4 | 5 | 6 | 7 | 8 | 9 | 10 | 11 |
| Pigment | Pigment dispersion 1 | | | | | | | | |
| Dispersion | Pigment dispersion 2 | 50 | | | | | | | |
| | Pigment dispersion 3 | | 50 | | | | | | |
| | Pigment dispersion 4 | | | 30 | | | | | |
| | Pigment dispersion 5 | | | | 50 | | | | |
| | Pigment dispersion 6 | | | | | 30 | | | |
| | Pigment dispersion 7 | | | | | | 50 | | |
| | Pigment dispersion 8 | | | | | | | | |
| | Pigment dispersion 9 | | | | | | | | |
| | Pigment dispersion 10 | | | | | | | | |
| | Pigment dispersion 11 | | | | | | | 50 | |
| | Pigment dispersion 12 | | | | | | | | 50 |
| | Pigment dispersion 13 | | | | | | | | |
| | Pigment dispersion 14 | | | | | | | | |
| | Pigment dispersion 15 | | | | | | | | |
| | Pigment dispersion 16 | | | | | | | | |
| | Pigment dispersion 17 | | | | | | | | |
| | Pigment dispersion 18 | | | | | | | | |
| | Pigment dispersion 19 | | | | | | | | |
| | Pigment dispersion 20 | | | | | | | | |
| | Pigment dispersion 21 | | | | | | | | |
| | Pigment dispersion 22 | | | | | | | | |
| | Pigment dispersion 23 | | | | | | | | |
| | Pigment dispersion 24 | | | | | | | | |
| | Pigment dispersion 25 | | | | | | | | |
| | Pigment dispersion 26 | | | | | | | | |
| | Pigment dispersion 27 | | | | | | | | |
| | Pigment dispersion 28 | | | | | | | | |
| | Pigment dispersion 29 | | | | | | | | |
| | Pigment dispersion 30 | | | | | | | | |
| | Pigment dispersion 31 | | | | | | | | |
| | Pigment dispersion 32 | | | | | | | | |
| | Pigment dispersion 33 | | | | | | | | |
| Additive | R-13 | | | | | | 4 | | |
| Water- | Glycerin | 20 | 10 | 10 | 10 | 10 | 10 | 10 | 10 |
| soluble | 1,3-butanediol | | 20 | 20 | 20 | 20 | 20 | 20 | 20 |
| solvent | Trimethylol propane | 5 | | | | | | | |
| | 2-pyrrolidone | 5 | | | | | | | |
| Solvent | High-purity water | Balance | Balance | Balance | Balance | Balance | Balance | Balance | Balance |
| | Total | 100 | 100 | 100 | 100 | 100 | 100 | 100 | 100 |

TABLE 4-3

| | | Example | | | | | | | |
|---|---|---|---|---|---|---|---|---|---|
| | | 12 | 13 | 14 | 15 | 16 | 17 | 18 | 19 |
| Pigment | Pigment dispersion 1 | | | | | | | | |
| Dispersion | Pigment dispersion 2 | | | | | | | | |
| | Pigment dispersion 3 | | | | | | | | |
| | Pigment dispersion 4 | | | | | | | | |
| | Pigment dispersion 5 | | | | | | | | |
| | Pigment dispersion 6 | | | | | | | | |
| | Pigment dispersion 7 | | | | | | | | |
| | Pigment dispersion 8 | | | | | | | | |
| | Pigment dispersion 9 | | | | | | | | |
| | Pigment dispersion 10 | | | | | | | | |
| | Pigment dispersion 11 | | | | | | | | |
| | Pigment dispersion 12 | | | | | | | | |
| | Pigment dispersion 13 | 50 | | | | | | | |
| | Pigment dispersion 14 | | 50 | | | | | | |
| | Pigment dispersion 15 | | | 50 | | | | | |
| | Pigment dispersion 16 | | | | 50 | | | | |
| | Pigment dispersion 17 | | | | | 50 | | | |
| | Pigment dispersion 18 | | | | | | 50 | | |
| | Pigment dispersion 19 | | | | | | | 50 | |
| | Pigment dispersion 20 | | | | | | | | 50 |
| | Pigment dispersion 21 | | | | | | | | |
| | Pigment dispersion 22 | | | | | | | | |
| | Pigment dispersion 23 | | | | | | | | |
| | Pigment dispersion 24 | | | | | | | | |
| | Pigment dispersion 25 | | | | | | | | |
| | Pigment dispersion 26 | | | | | | | | |
| | Pigment dispersion 27 | | | | | | | | |
| | Pigment dispersion 28 | | | | | | | | |
| | Pigment dispersion 29 | | | | | | | | |
| | Pigment dispersion 30 | | | | | | | | |
| | Pigment dispersion 31 | | | | | | | | |
| | Pigment dispersion 32 | | | | | | | | |
| | Pigment dispersion 33 | | | | | | | | |
| Additive | R-13 | | | | | | | | |
| Water- | Glycerin | 10 | 10 | 10 | 10 | 10 | 10 | 10 | 10 |
| soluble | 1,3-butanediol | 20 | 20 | 20 | 20 | 20 | 20 | 20 | 20 |
| solvent | Trimethylol propane | | | | | | | | |
| | 2-pyrrolidone | | | | | | | | |
| Solvent | High-purity water | Balance | Balance | Balance | Balance | Balance | Balance | Balance | Balance |
| | Total | 100 | 100 | 100 | 100 | 100 | 100 | 100 | 100 |

TABLE 4-4

| | | Example | | | | | | | |
|---|---|---|---|---|---|---|---|---|---|
| | | 20 | 21 | 22 | 23 | 24 | 25 | 26 | 27 |
| Pigment | Pigment dispersion 1 | | | | | | | | |
| Dispersion | Pigment dispersion 2 | | | | | | | | |
| | Pigment dispersion 3 | | | | | | | | |
| | Pigment dispersion 4 | | | | | | | | |
| | Pigment dispersion 5 | | | | | | | | |
| | Pigment dispersion 6 | | | | | | | | |
| | Pigment dispersion 7 | | | | | | | | |
| | Pigment dispersion 8 | | | | | | | | |
| | Pigment dispersion 9 | | | | | | | | |
| | Pigment dispersion 10 | | | | | | | | |
| | Pigment dispersion 11 | | | | | | | | |
| | Pigment dispersion 12 | | | | | | | | |
| | Pigment dispersion 13 | | | | | | | | |
| | Pigment dispersion 14 | | | | | | | | |
| | Pigment dispersion 15 | | | | | | | | |
| | Pigment dispersion 16 | | | | | | | | |
| | Pigment dispersion 17 | | | | | | | | |
| | Pigment dispersion 18 | | | | | | | | |
| | Pigment dispersion 19 | | | | | | | | |
| | Pigment dispersion 20 | | | | | | | | |
| | Pigment dispersion 21 | 50 | | | | | | | |
| | Pigment dispersion 22 | | 50 | | | | | | |
| | Pigment dispersion 23 | | | 50 | | | | | |
| | Pigment dispersion 24 | | | | 50 | | | | |
| | Pigment dispersion 25 | | | | | 50 | | | |
| | Pigment dispersion 26 | | | | | | 50 | | |
| | Pigment dispersion 27 | | | | | | | 50 | |
| | Pigment dispersion 28 | | | | | | | | 50 |
| | Pigment dispersion 29 | | | | | | | | |
| | Pigment dispersion 30 | | | | | | | | |
| | Pigment dispersion 31 | | | | | | | | |
| | Pigment dispersion 32 | | | | | | | | |
| | Pigment dispersion 33 | | | | | | | | |
| Additive | R-13 | | | | | | | | |
| Water- | Glycerin | 10 | 10 | 10 | 10 | 10 | 10 | 10 | 10 |
| soluble | 1,3-butanediol | 20 | 20 | 20 | 20 | 20 | 20 | 20 | 20 |
| solvent | Trimethylol propane | | | | | | | | |
| | 2-pyrrolidone | | | | | | | | |
| Solvent | High-purity water | Balance | Balance | Balance | Balance | Balance | Balance | Balance | Balance |
| | Total | 100 | 100 | 100 | 100 | 100 | 100 | 100 | 100 |

TABLE 4-5

| | | Example | | | |
|---|---|---|---|---|---|
| | | 28 | 29 | 30 | 31 |
| Pigment | Pigment dispersion 1 | | | | |
| Dispersion | Pigment dispersion 2 | | | | |
| | Pigment dispersion 3 | | | | |
| | Pigment dispersion 4 | | | | |
| | Pigment dispersion 5 | | | | |
| | Pigment dispersion 6 | | | | |
| | Pigment dispersion 7 | | | | |
| | Pigment dispersion 8 | | | | |
| | Pigment dispersion 9 | | | | |
| | Pigment dispersion 10 | | | | |
| | Pigment dispersion 11 | | | | |
| | Pigment dispersion 12 | | | | |
| | Pigment dispersion 13 | | | | |
| | Pigment dispersion 14 | | | | |
| | Pigment dispersion 15 | | | | |
| | Pigment dispersion 16 | | | | |
| | Pigment dispersion 17 | | | | |
| | Pigment dispersion 18 | | | | |
| | Pigment dispersion 19 | | | | |
| | Pigment dispersion 20 | | | | |
| | Pigment dispersion 21 | | | | |
| | Pigment dispersion 22 | | | | |
| | Pigment dispersion 23 | | | | |
| | Pigment dispersion 24 | | | | |
| | Pigment dispersion 25 | | | | |
| | Pigment dispersion 26 | | | | |
| | Pigment dispersion 27 | | | | |
| | Pigment dispersion 28 | | | | |
| | Pigment dispersion 29 | 50 | | | |
| | Pigment dispersion 30 | | 50 | | |
| | Pigment dispersion 31 | | | 50 | |
| | Pigment dispersion 32 | | | | 50 |
| | Pigment dispersion 33 | | | | |
| Additive | R-13 | | | | |
| Water- | Glycerin | 10 | 10 | 10 | 10 |
| soluble | 1,3-butanediol | 20 | 20 | 20 | 20 |
| solvent | Trimethylol propane | | | | |
| | 2-pyrrolidone | | | | |
| Solvent | High-purity water | Balance | Balance | Balance | Balance |
| | Total | 100 | 100 | 100 | 100 |

TABLE 4-6

| | | Comparative Example | | | | |
|---|---|---|---|---|---|---|
| | | 1 | 2 | 3 | 4 | 5 |
| Pigment | Pigment dispersion 1 | | | | | |
| Dispersion | Pigment dispersion 2 | | | | | |
| | Pigment dispersion 3 | | | | | |
| | Pigment dispersion 4 | | | | | |
| | Pigment dispersion 5 | | | | | |
| | Pigment dispersion 6 | | | | | |
| | Pigment dispersion 7 | | 50 | | | |
| | Pigment dispersion 8 | | | 30 | | |
| | Pigment dispersion 9 | | | | 50 | |
| | Pigment dispersion 10 | | | | | 30 |
| | Pigment dispersion 11 | | | | | |
| | Pigment dispersion 12 | | | | | |
| | Pigment dispersion 13 | | | | | |
| | Pigment dispersion 14 | | | | | |
| | Pigment dispersion 15 | | | | | |
| | Pigment dispersion 16 | | | | | |
| | Pigment dispersion 17 | | | | | |
| | Pigment dispersion 18 | | | | | |
| | Pigment dispersion 19 | | | | | |
| | Pigment dispersion 20 | | | | | |
| | Pigment dispersion 21 | | | | | |
| | Pigment dispersion 22 | | | | | |
| | Pigment dispersion 23 | | | | | |
| | Pigment dispersion 24 | | | | | |
| | Pigment dispersion 25 | | | | | |
| | Pigment dispersion 26 | | | | | |
| | Pigment dispersion 27 | | | | | |
| | Pigment dispersion 28 | | | | | |
| | Pigment dispersion 29 | | | | | |
| | Pigment dispersion 30 | | | | | |
| | Pigment dispersion 31 | | | | | |
| | Pigment dispersion 32 | | | | | |
| | Pigment dispersion 33 | 50 | | | | |
| Additive | R-13 | | | | | |
| Water- | Glycerin | 10 | 10 | 10 | 10 | 10 |
| soluble | 1,3-butanediol | 20 | 20 | 20 | 20 | 20 |
| solvent | Trimethylol propane | | | | | |
| | 2-pyrrolidone | | | | | |
| Solvent | High-purity water | Balance | Balance | Balance | Balance | Balance |
| | Total | 100 | 100 | 100 | 100 | 100 |

The viscosities of the pigment dispersions 1 to 33, and the inks of Examples 1 to 31 and Comparative Examples 1 to 5 were measured by, e.g., a viscometer RE80L from TOKI SANGYO CO., LTD. at 25° C., adjusting the rotational number at from 50 to 100 rpm according the viscosities. As an index of dispersion stability of the pigment dispersion and the pigment in the ink, the initial viscosities of the pigment dispersions and the inks were measured to evaluate under the following standard.

As for the preservability, after the initial viscosities thereof were measured, each of them were placed in a polyethylene container and sealed. The viscosity after stored at 70° C. for 1 week was measured to evaluate under the following standard, compared with the initial viscosity.

### [Pigment Dispersion Evaluation Standard]

Initial viscosity

Good: less than 7 mPa·s

Average: not less than 7 mPa·s and less than 20 mPa·s

Poor: not less than 20 mPa·s
Preservability (change rate of viscosity after stored)

Good: less than 5%

Average: not less than 5% less than 50%

Poor: not less than 50%

### [Ink Evaluation Standard]

Initial viscosity

Good: less than 9 mPa·s

Average: not less than 9 mPa·s and less than 20 mPa·s

Poor: not less than 20 mPa·s
Preservability (change rate of viscosity after stored)

Good: less than 5%

Average: not less than 5% less than 50%

Poor: not less than 50%

### <Printed Image Evaluation>

Each printed image density by the inks of Examples 1 to 31 and Comparative Examples 1 to 5 was evaluated.

A drive voltage of piezo element of an inkjet printer IPSiO GX3000 from Ricoh Company, Ltd. was changed to uniformly discharge the ink such that the same amount of the ink adheres to a recording material.

After a chart on which “black square” black and each color having 64 point are described by Microsoft Word 2003 was printed on My Paper having a weight of 69.6 g/m², a sizing degree of 23.2 sec and an air permeability of 21.0 sec, the image density of “black square” was evaluated using X-Rite938 from X-Rite, Inc. Then, the printing mode was “plain paper-fast” mode by a driver of the printer.

Image density was evaluated under the following standard. The results are shown in Table 5.

### [Evaluation Standard]

Excellent: OD value Black not less than 1.30
Yellow not less than 0.80
Magenta not less than 1.00
Cyan not less than 1.10

Good: OD value Black not less than 1.20 less than 1.30
Yellow not less than 0.75 less than 0.80
Magenta not less than 0.90 less than 1.00
Cyan not less than 1.00 less than 1.10

Average: OD value Black not less than 1.10 less than 1.20
Yellow not less than 0.70 less than 0.75
Magenta not less than 0.80 less than 0.90
Cyan not less than 0.90 less than 1.00

Fair: OD value Black not less than 1.00 less than 1.10
Yellow not less than 0.65 less than 0.70
Magenta not less than 0.70 less than 0.80
Cyan not less than 0.80 less than 0.90

Poor: OD value Black less than 1.00
Yellow less than 0.65
Magenta less than 0.70
Cyan less than 0.80

TABLE 5

| | Pigment Dispersion | | Ink | | |
|---|---|---|---|---|---|
| | Viscosity | Preservability | Viscosity | Preservability | Image Density |
| Example 1 | Good | Good | Good | Average | Excellent |
| Example 2 | Good | Good | Good | Average | Excellent |
| Example 3 | Good | Good | Good | Average | Excellent |
| Example 4 | Good | Good | Good | Average | Excellent |
| Example 5 | Good | Good | Average | Good | Excellent |
| Example 6 | Good | Good | Good | Average | Excellent |
| Example 7 | Good | Good | Good | Average | Excellent |
| Example 8 | Good | Good | Good | Average | Excellent |
| Example 9 | Good | Average | Good | Average | Excellent |
| Example 10 | Good | Good | Average | Average | Average |
| Example 11 | Good | Good | Average | Average | Average |
| Example 12 | Good | Good | Average | Average | Good |
| Example 13 | Good | Good | Average | Average | Good |
| Example 14 | Average | Good | Average | Average | Excellent |
| Example 15 | Good | Good | Good | Average | Excellent |
| Example 16 | Average | Good | Average | Average | Excellent |
| Example 17 | Average | Good | Average | Average | Excellent |
| Example 18 | Good | Good | Good | Average | Excellent |
| Example 19 | Good | Average | Average | Average | Good |
| Example 20 | Good | Good | Average | Average | Average |
| Example 21 | Good | Good | Average | Average | Good |
| Example 22 | Good | Good | Average | Average | Good |
| Example 23 | Good | Good | Good | Average | Excellent |
| Example 24 | Average | Good | Average | Average | Excellent |
| Example 25 | Good | Average | Average | Average | Average |
| Example 26 | Average | Average | Average | Average | Good |
| Example 27 | Good | Good | Good | Average | Excellent |
| Example 28 | Good | Good | Good | Average | Excellent |
| Example 29 | Good | Good | Good | Average | Excellent |
| Example 30 | Good | Good | Good | Average | Excellent |
| Example 31 | Good | Good | Good | Average | Excellent |
| Comparative | Average | Poor | Average | Poor | Average |
| Example 1 | | | | | |
| Comparative | Average | Poor | Average | Average | Fair |
| Example 2 | | | | | |
| Comparative | Average | Average | Average | Average | Fair |
| Example 3 | | | | | |
| Comparative | Average | Poor | Average | Poor | Fair |
| Example 4 | | | | | |
| Comparative | Average | Average | Average | Average | Fair |
| Example 5 | | | | | |

Having now fully described the invention, it will be apparent to one of ordinary skill in the art that many changes and modifications can be made thereto without departing from the spirit and scope of the invention as set forth therein.

What is claimed is:

1. An ink for inkjet recording, comprising:
water;
a water-soluble solvent;
a pigment; and
a copolymer comprising a salt of phosphonic acid group,
wherein the copolymer comprising a salt of phosphonic acid group comprises the following structural units having the following formulae (1) and (2): 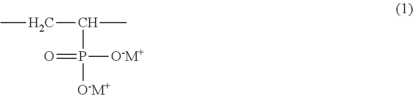
wherein M⁺ represents a cation of alkali metals, an organic ammonium ion or a proton, and wherein not less than a half of M^{±} are the cation of alkali metals and the organic ammonium ion;

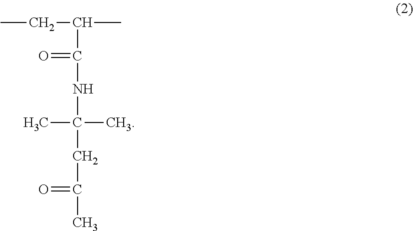

2. The ink for inkjet recording of claim 1, wherein the copolymer comprising a salt of phosphonic acid group comprises the structural unit having the formula (1) in an amount of from 20 to 60% by weight.

3. The ink for inkjet recording of claim 2, wherein the copolymer comprising a salt of phosphonic acid group comprises the structural unit having the formula (1) in an amount of from 30 to 60% by weight.

4. The ink for inkjet recording of claim 1, wherein the copolymer comprising a salt of phosphonic acid group has a weight-average molecular weight of from 2,000 to 30,000.

5. An ink for inkjet recording, comprising:
water;
a water-soluble solvent;
a pigment; and
a copolymer comprising a salt of phosphonic acid,
wherein the copolymer comprising a salt of phosphonic acid group is synthesized from a vinyl phosphonic acid group and a monomer having the following formula (3) as starting materials:

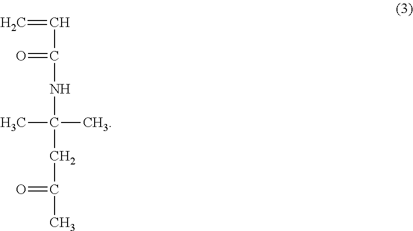

6. An ink cartridge containing the ink for inkjet recording of claim 1 in a container.

7. An inkjet recording method, comprising:
applying a stimulation to the ink for inkjet recording of claim 1 to fly and record an image.

8. An inkjet recorder, comprising:
a flyer configured to apply a stimulation to the ink for inkjet recording of claim 1 to fly and record an image.

9. An ink-recorded matter having an image recorded by the ink for inkjet recording according to claim 1.
